(19) United States
(12) Patent Application Publication
(10) Pub. No.: US 2014/0015756 A1
(43) Pub. Date: Jan. 16, 2014

(54) ELECTRONIC DEVICE HAVING TOUCH-SENSITIVE PROTECTIVE COVER

(71) Applicant: Fitipower Integrated Technology, Inc., Hsinchu City (TW)

(72) Inventor: CHEN-CHI YANG, Hsinchu (TW)

(21) Appl. No.: 13/939,319

(22) Filed: Jul. 11, 2013

(30) Foreign Application Priority Data
Jul. 16, 2012 (TW) 101125497

(51) Int. Cl. G06F 3/041

(52) U.S. Cl. CPC G06F 3/041
USPC 345/168; 345/173

(57) ABSTRACT

An electronic device includes a protective cover. A portion of the protective cover is capable of both displaying and accepting touch input. The display by the protective cover may repeat the display by the electronic device, or the display of the protective cover may be independent. The touch display portion detects touch operations applied on the touch display portion, and outputs signals to the electronic device to execute corresponding functions according to the touch operations.

### BACKGROUND

1. Technical Field

Embodiments of the present disclosure relate to electronic devices, and particularly to, an electronic device having a protective cover for protecting a display of the electronic device.

2. Description of Related Art

Many electronic devices, such as smart phones and tablet computers, have a protective cover (e.g., smart cover) used for protecting displays of the electronic devices.

Usually, the cover has no function beyond being used to protect the display. Therefore, there is room for improvement in the art.

### BRIEF DESCRIPTION OF THE DRAWINGS

FIG. 1 illustrates a schematic view of one embodiment of an electronic device.

FIG. 2 illustrates a schematic block diagram of the electronic device of FIG. 1.

FIG. 3 illustrates a schematic view of a protective cover of FIG. 1 in an input mode.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

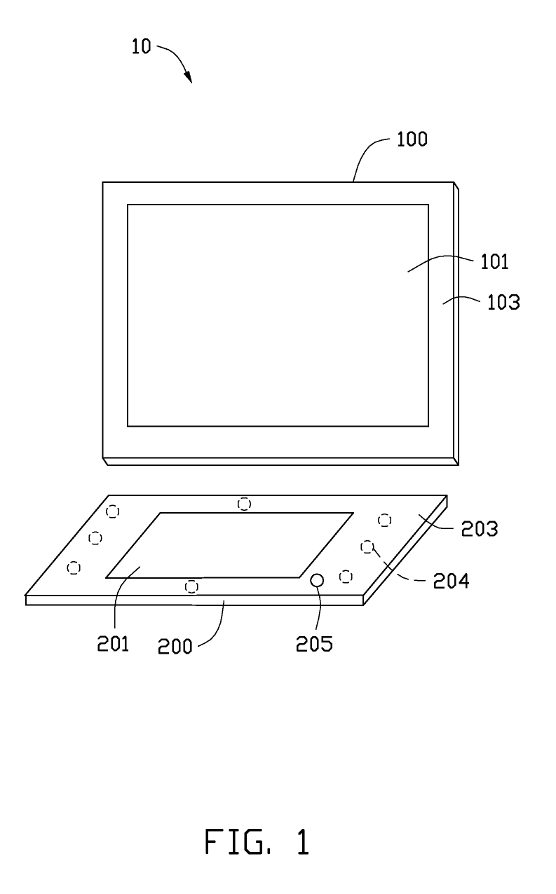

Referring to FIG. 1, an electronic device 10 including a display 100 and a protective cover 200 is shown. The protective cover 200 is configured to cover the display 100 to protect the display 100 against damage. In the embodiment, the display 100 is capable of communicating with the protective cover 200 via a wired or a wireless connection.

The display 100 includes a display area 101 and a frame area 103. The display area 101 is configured to display data, such as images, pictures, texts, icons, or other data. The frame area 103 surrounds the display 100 to support and protect the display area 101. In the embodiment, the frame area 103 may be made of metal materials (e.g., iron or ferroalloy) that can be attracted by magnets. The display 100 may be a liquid crystal display (LCD) or an Organic Light Emitting Display (OLED). The electronic device 10 may be a smart phone, a tablet computer, or other similar portable device.

The protective cover 200 includes a touch display area 201 and a magnetic area 203. The touch display area 201 is configured to display data and detect touch operations applied on the touch display area 201.

The magnetic area 203 surrounds the touch display area 203 and corresponds to the frame area 103 of the display 100. The magnetic area 203 includes a plurality of magnetic elements 204 configured to attract the frame area 101 of the display 100. When the protective cover 200 covers the display 100, the protective cover 200 is held to the display 100 via the magnetic elements 24, to protect the display 100.

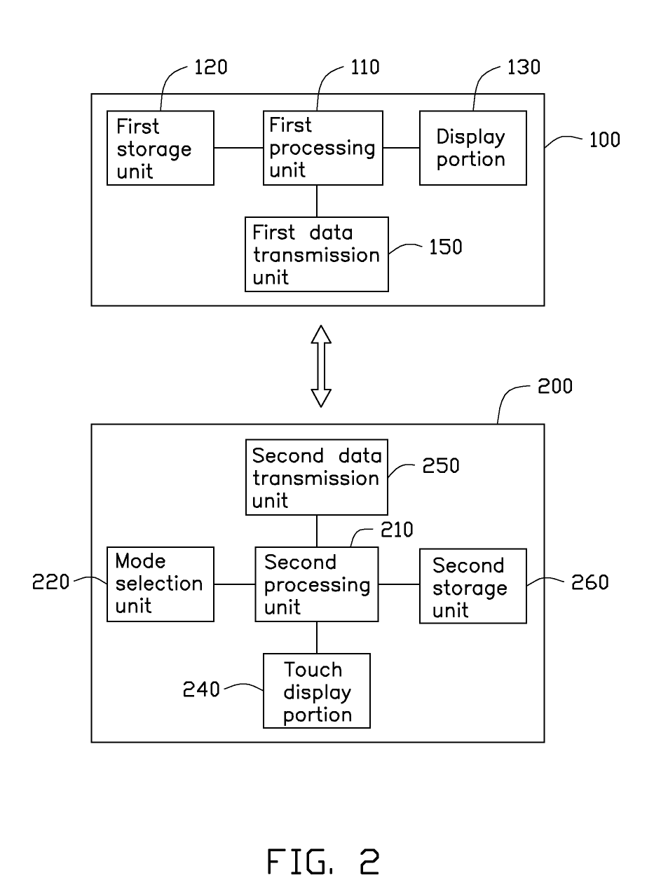

Referring to FIG. 2, a schematic block diagram of the electronic device 10 is shown. The display 100 further includes a first processing unit 110, a first storage unit 120, a display portion 130, and a first data transmission unit 150. The first storage 120 stores a plurality of data, such as, pictures, images, videos, music, and other kinds of data. The display portion 130 may be a liquid display panel or an electroluminescent display panel located at the display area 101. The first data transmission unit 150 is configured to transmit data between the display 100 and the protective cover 200.

The protective cover further includes a second processing unit 210, a mode selection unit 220, a touch display portion 240, a second data transmission unit 250 and a second storage unit 260.

The second data transmission unit 250 communicates with the first data transmission unit 150, to establish a data communication between the display 100 and the protective cover 200. In the embodiment, data communication between the first and second data transmission units 150, 250 may be established via a wireless connection (e.g., BLUETOOTH® connection or WIFI® connection), or via a wired connection such as universal serial bus (USB) connection.

The touch display portion 240 is located at the touch display area 201. The touch display portion 240 detects touch operations applied on the touch display portion 240, and outputs signals to the display 100 through the second data transmission unit 250 to control the display 100 to execute corresponding functions according to the touch operations.

In the embodiment, the protective cover 200 can work in a plurality of working modes including a display mode, an input mode, and a protection mode. The mode selection unit 250 selects one of the working modes according to an operation of a user, to control the protective cover 200 to work in the selected working mode.

In the embodiment, when the protective cover 200 works in the display mode, the protective cover 200 is configured to display data prestored in the second storage unit 260, or synchronously display the same information as displayed on the display 100. The protective cover 200 may acquire the display information of the display 100 through the second data transmission unit 250 in real-time, and then display the acquired information. The protective cover 200 may be an electronic display paper. The protective cover 200 further includes a power supply unit (not shown), such as a battery to supply power for the protective cover 200.

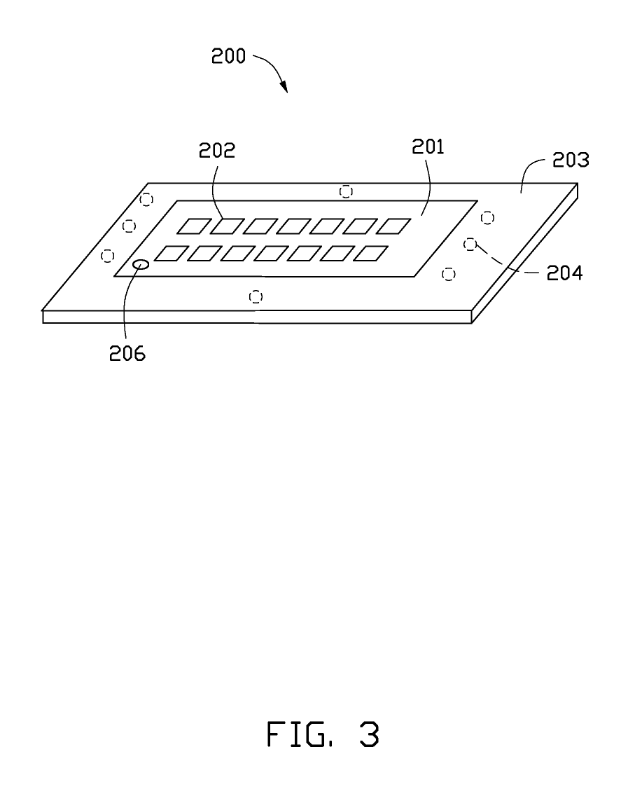

When the protective cover 200 works in the input mode, the protective cover 200 is used as a peripheral device configured for inputting information. The input information from the protective cover 200 is transmitted to the display 100 through the first and second data transmission units 150, 250. In one example, referring to FIG. 3, a virtual keyboard 201 including a plurality of touch keys 202 are displayed on the touch display portion 240 of the protective cover 200. The user can input information using the touch keys 202. The second processing unit 210 receives the input information and transmits the received information to the display 100 through the second data transmission unit 250. The first processing unit 110 receives the information transmitted from the protective cover 200 through the first data transmission unit 150, and controls the display 100 to execute corresponding functions according to the information.

When the protective cover 200 works in the protection mode, the protective cover 200 covers and is held on the display 100 by magnetism to protect the display 100, and the second processing unit 210 automatically powers off the touch display portion 240. At this time, the touch display portion 240 of the protective cover 200 is facing the display portion 130 of the display 100, and only a back surface of the protective cover 200, opposite to the touch display portion 240, is exposed, thus both the display portion 130 and the touch display portion 240 are protected. In another embodiment, when the protective cover 200 works in the protection mode, the back surface of the protective cover 200 opposite to the touch display portion 240 can support and present the display portion 130 of the display 100, for exposure and access to the touch display portion 240. Thus, the touch display portion 240 can be further used to display information when the protective cover 200 is working in the protection mode.

In one embodiment, the protective cover 200 further includes a mode switching button 205 as shown in FIG. 1. The mode switching button 205 is configured to switch among working modes of the protective cover 200. In another embodiment, as shown in FIG. 3, the virtual keyboard includes a mode switching icon 206 that performs the function of the mode switching button 205. When the mode switching button 205 or the mode switching icon 206 is operated, the protective cover 200 is switched from one working mode to another working mode.

The protective cover 200 of the present invention is not only used as a protective cover of the electronic device 10 to protect the display 100, but also used as a peripheral device. Thus, the function of the protective cover of the electronic device 10 is usefully expanded.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display; and
a protective cover configured to cover the display, the protective cover comprising:
a touch display portion communicating with the display, the touch display portion detecting touch operations applied on the touch display portion, and outputting signals to the display to control the display to execute corresponding functions according to the touch operations.

2. The electronic device according to claim 1, wherein the display comprises a display area, a frame area surrounding the display area, and a display portion located at the display area; the protective cover comprises a touch display area and a magnetic portion surrounding the touch display area, the touch display portion is located at the touch display area.

3. The electronic device according to claim 2, wherein the frame is made of metal materials, the magnetic portion comprises a plurality of magnetic elements, and the magnetic portion is held to the frame area via the magnetic elements when the protective cover covers the display.

4. The electronic device according to claim 1, wherein the display further comprises a first processing unit and a first data transmission unit, the protective cover further comprises a second processing unit and a second data transmission unit, the second data transmission unit communicates with the first data transmission unit to establish a data communication between the display and the protective cover, and the first processing unit receives the signals from the touch display using the first data transmission unit and controls the display to execute the corresponding functions according to the signals.

5. The electronic device according to claim 1, wherein the protective cover has a plurality of working modes comprising a display mode, an input mode, and a protection mode, the protective cover further comprises a mode selection unit that selects one of the working modes according an operation of a user, to control the protective cover to work in the selected working mode.

6. The electronic device according to claim 5, wherein when the protective cover works in the display mode, the protective cover is configured to display data or synchronously display the same information as displayed on the display.

7. The electronic device according to claim 5, wherein when the protective cover works in the input mode, the protective cover is used as a peripheral device of the display device to input information and transmits the input information to the display.

8. The electronic device according to claim 7, wherein a virtual keyboard comprising a plurality touch keys are displayed on the touch display portion of the protective cover, the virtual keyboard is configured to input information according to touch operations applied on the touch keys.

9. The electronic device according to claim 5, wherein when the protective cover works in the protection mode, the protective cover covers and is held on the display by magnetism, and the touch display portion is powered off and facing the display, to protected the touch display portion and the display.

10. The electronic device according to claim 5, wherein the protective cover further comprises a mode switching button configured to switch the working modes of the protective cover, when the mode switching button is operated, the protective cover is switched from one working mode to another working mode.

11. The electronic device according to claim 8, wherein the virtual keyboard includes a mode switching icon configured to switch the working modes of the protective cover, when the mode switching button is operated, the protective cover is switched from one working mode to another working mode.

12. The electronic device according to claim 1, wherein the display is a liquid crystal display (LCD) or an Organic Light Emitting Display (OLED).
